(19) United States
(12) Patent Application Publication
(10) Pub. No.: US 2006/0147086 A1
(43) Pub. Date: Jul. 6, 2006

(54) Process and arrangement for remote transmission of data including at least one image data

(75) Inventor: Anatoli Stobbe, Barsinghausen (DE)

Correspondence Address: WILLIAM COLLARD;COLLARD & ROE, P.C., 1077 NORTHERN BOULEVARD, ROSLYN, NY, 11576, US

(73) Assignee: ASTRA Gesellschaft fur Asset Management mbH & Co. KG

(21) Appl. No.: 11/320,084

(22) Filed: Dec. 28, 2005

(30) Foreign Application Priority Data
Dec. 30, 2004 (DE) 10 2004 063 796.2

(51) Int. Cl. G06K 9/00; G06K 9/46

(52) U.S. Cl. 382/103; 382/243

(57) ABSTRACT

A process and an arrangement for remote transmission of image data. Image data of a total image are transmitted at least once. In addition, image data at least of a section of the total image relevant for monitoring are transmitted, and updated image data of at least one section are transmitted more frequently or at shorter time intervals than the image data of the total image and the section of the total image is replaced by updated image data.

### BACKGROUND OF THE INVENTION

1. Field of the Invention

The invention relates to a process and arrangement for remote transmission of image data.

2. The Prior Art

For the purpose of monitoring objects, it is known to detect image data and other data detectable with sensors locally on or in the object to be monitored or in the vicinity of the object to be monitored and to transfer same to a central monitoring unit. With short transmission distances, private cable or radio networks, which have the required bandwidth for continuous transmission of high data rates and thus also enable continuous transmission of animated images, this monitoring can be accomplished cost-effectively.

For transmission over longer distances or with the absence of private cable or radio networks, public communications networks must be used. Balancing of transmitted data takes place according to time or volume, such as the Internet, which offer only a limited bandwidth specific to system, such as a fixed telephone network or a mobile radio network. In this case, continuous transmission of image data of high-resolution images is not economical or impossible.

### SUMMARY OF THE INVENTION

It is therefore an object of the invention to provide a process and an arrangement for remote transmission of image data and which enable real-time transmission of data relevant for effective monitoring.

This object is accomplished by a process for remote transmission of data, wherein image data of a total image is transmitted at least once, and image data at least of a section of the total image relevant to monitoring are transmitted and updated. The image data of at least one section are transmitted more frequently or at shorter time intervals than the image data of the total image and the section of the total image is replaced by updated image data.

After transmission of the total image, a section of the total image is transferred more often than the total image and the section of the total image is replaced by the updated section. The section comprises the data relevant for effective monitoring. The total overview is preserved by the total image for the monitoring staff, and at the same time that for monitoring of relevant sections is updated in real time. The total volume of data to be transmitted is thus greatly reduced.

Initializing criteria can be set, and when these are met, image data of at least one section are transmitted at least once. Alternatively, a pre-defined action, such as altering the camera setting, activating sensors, activating optical or acoustic signallers, activating light sources, activating alarms, is triggered.

The time and frequency of transmission of image data can be controlled via the initializing criteria, and updating as required can thus be effected. The total volume of data to be transmitted as well as the operating life of the transmission medium can be limited to the extent necessary for effective monitoring. Further to this, at least one of the pre-defined actions can be triggered automatically and thus without any data dialogue with the central monitoring unit.

Modifications to the camera setting, such as horizontal or vertical angle or zoom, can be evaluated as initializing criteria. Renewed transmission of data of the total image and/or of the section can thus be limited to changes to the camera setting when other initializing criteria fail to materialize.

When the initializing criteria are fulfilled, at least one section of the total image can be fixed anew or on the basis of stored criteria.

With subsequent transmission of updated image data of at least one section, the total volume of data to be transmitted as well as the operating life of the transmission medium is limited to the extent necessary for effective monitoring.

The data of an antiburglar sensor or a meteorological sensor or an acoustic sensor or a motion sensor or a light barrier sensor or a combination of at least two of these sensors or at least a detection area fixed within the total image, in which changes of image information occur, can be used as initializing criteria.

At the same time, at least one detection area can be congruent with at least one section of the total image. But there is also the possibility of arranging the detection area inside or outside the section of the total image or inside and outside the section and overlapping it.

Through evaluation of data from at least one sensor or a combination of sensors, events of different physical natures can be employed for initializing. The reliability of initializing can be improved by combined evaluation through redundancy of different physical effects of the same event.

At least one detection area can be newly established as altered or on the basis of stored criteria when the initializing criteria are fulfilled by a changed camera setting.

The detection area within the total image is also automatically adapted thereby to a changed camera setting.

Changes of image information, the quantity of image information, or the localized distribution of image information or a combination of at least two of the initializing criteria, or these factors over a time span, can be evaluated as initializing criteria for the data of a detection area which can be fixed within the total image.

Motion events can be utilized here as initializing criteria. By assessing changes to the quantity of image information or to the local distribution of image information per se or within a time span, analysis can also be made with respect to the cause of the changes. For example, changes in the image information caused by meteorological influences or criteria of changes in image information caused by people or vehicles can be distinguished in this way.

The initializing criteria can be assessed by an internal detection decision circuit of the camera and the transmission of data of the total image or of the section over a local network can be induced by the internal detection decision circuit of the camera only when at least one initializing criterion or a combination of initializing criteria is induced.

The shift in assessing initializing criteria in an internal detection decision circuit of the camera, however, enables a local network to transmit image data only in the event of changes. In the process, the required transmission bandwidth of the local network is reduced. This is particularly advantageous when there are several cameras connected to the local network and in environments in which several adjacent local networks are running parallel, or where there is only a narrowband radio channel available.

Alternatively, the initializing criteria can be assessed by an internal detection decision circuit of the camera, and when an initializing criterion or a combination of initializing criteria is fulfilled, at least one local action, in particular a physical event such as sound or light, can be triggered. Then the initializing criteria can be continued individually or in combination, or in combination with at least a local action, or analysed afresh and the transmission of data of the total image or of the section over a local network can be caused by the internal detection decision circuit of the camera, only when an initializing criterion or a combination of initializing criteria is fulfilled ongoing or afresh.

Through this, the attempt can first be made to warn intruders, who have breached the area to be monitored and are moving around, before the transmission of data of the total image or the section is undertaken over a local network. Likewise, artefacts can also be recognised and filtered out, which are not triggered by intruders in the area to be monitored. The required transmission bandwidth of the local network is thus again reduced.

The at least one detection area for a camera setting can be fixed once or by ongoing checks.

Local areas of the object to be monitored or its environment which are significant for monitoring can be defined. Therefore only those events are assessed, which are relevant for initializing of the transmission of image data. Other events remain unobserved and thus do not augment the total volume of data to be transmitted.

The at least one detection area can be delimited temporarily once or by ongoing transmissions and restricted expanded by statistical assessment of changes in image information inside or outside the temporary detection area.

Automatic dynamic matching of the detection area is also possible, improving the reliability of initializing, and whereby the total volume of data to be transmitted is adapted according to need at the same time.

Furthermore, at least one section of the total image can be delimited temporarily once or by ongoing transmissions and restricted expanded by statistical assessment of changes in image information inside or outside the detection area.

This also enables dynamic matching of the section of the total image and increases the reliability of transmitting all relevant image data updated.

The image data of the total image can be transmitted as an animated image in compressed form or as a still image in compressed form. Also, the image data of at least one section of the total image can be transmitted as an animated image in compressed form or as still image in compressed form.

Through use of compression methods, the total volume of data to be transmitted can thus be further reduced.

In addition to the image data, data of an antiburglar sensor or a meteorological sensor or an acoustic sensor or a motion sensor or a combination of at least two of the sensors can be transmitted uncompressed or in compressed form.

These data provide the monitoring staff additional information on the object to be monitored and also enable subsequent checking of initializing criteria.

After transmission of the total image, including balancing of image parameters, such as brightness or contrast or a combination of brightness and contrast or transmission, the at least one section of the total image can be integrated in the total image. This measure gives ergonomic improvement in the total image containing the section.

In addition, at least one section of the total image can be marked inside the total image. In addition, at least one detection area inside the total image can be marked. The monitoring of the total image with respect to the relevant updated section and the detection area is hereby facilitated.

During transmission of image data from several cameras, priority configurations can be assigned to the image data and the available transmission bandwidth or transmission sequence of these image data is allocated according to their priority configurations. The priority configurations can be weighted according to finalized or dynamic criteria, such as relevance of the image data for the object monitoring or a section of the total image or the initializing criteria or a combination of these criteria.

Important image data is given a higher priority and thus primacy compared to less important image data. The important image data can thus be transmitted earlier and more frequently. Despite limited transmission bandwidth, immediate transmission of relevant image data is then achieved.

During transmission of image data from several cameras, which capture adjacent or overlapping areas of a total image, the image data can be expanded into a total image.

Total images in the form of panoramic views or all-around views with high image resolution can be created from images originating from individual cameras. Total images in user-defined height and width dimensions are also possible.

With additional transmission of data of an antiburglar sensor or a meteorological sensor or an acoustic sensor or a motion sensor, in addition to the transmission of image data, priority configurations can be assigned to the data of the antiburglar sensor, of the meteorological sensor, of the acoustic sensor, of the motion sensor, of the light barrier sensor and the image data, and the available transmission bandwidth is allocated to these data based on their priority configurations.

Important information, such as image data and data of an acoustic sensor, can be given priority when an event occurs, as compared to other data. Despite limited transmission bandwidth, this achieves real-time transmitting of relevant image data and acoustic data.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a camera image of an object to be monitored;

FIG. 2 shows a block diagram of a monitoring device arranged on the object to be monitored;

FIG. 3 shows a detailed block diagram of a signal-processing device of the monitoring device for a camera;

FIG. 4 shows a detailed block diagram of a signal-processing device of the monitoring device for several cameras; and

FIG. 5 shows a block diagram of the decoder for the arrangement according to the invention.

### DETAILED DESCRIPTION OF THE PREFERRED EMBODIMENT

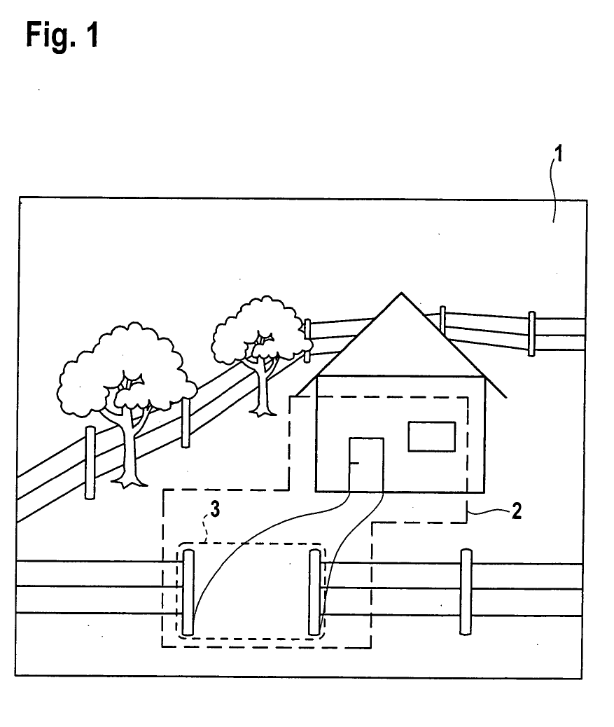

Referring now in detail to the drawings, FIG. 1 shows a camera image of an object to be monitored. Marked inside the illustrated total image 1 is a section 20, which comprises a door and a window of the building as well as an access. Another detection area 3 is marked at the beginning of the access.

The camera image delivers a total image of the object and its environment, which is important as context for monitoring. The image data of total image 1 are transferred to a central monitoring unit. In order to obtain image information on the perpetrator in the event of a break-in, the possible image area is established, inside which the perpetrator could move during his break-in attempt. This is not the total image area, but only the access as well as the area in the vicinity of the door and the window. This area is determined by the marked section 2.

To obtain an overall view of the object and its environment, total image 1 is transferred once or at longer time intervals as a still image. Only a comparatively small volume of image data and transmission time are employed for transmission via a transmission medium. To obtain rapid updating of the security-relevant area, image data of marked section 2 are transmitted more frequently. This can occur through a sequence of still images at brief time intervals or also through animated images, which are however limited to section 2. Since fewer image data have to be transmitted than for the total image, only a lesser total volume of data is transmitted via the transmission medium, or a lesser transmission time is needed in the event of transmission of still images. The central monitoring unit receives updated information all the same.

In addition, a detection area 3 can be established which the perpetrator must cross. Image modifications of this detection area can be utilized as an initializing criterion for transmission of image data of section 2, as well as for activating sensors and actuators associated with section 2.

With respect to the central monitoring unit, the image data of section 2 are then inserted into the image data of the previously transmitted or already available total image 1, in that the corresponding image areas are replaced by the updated image information.

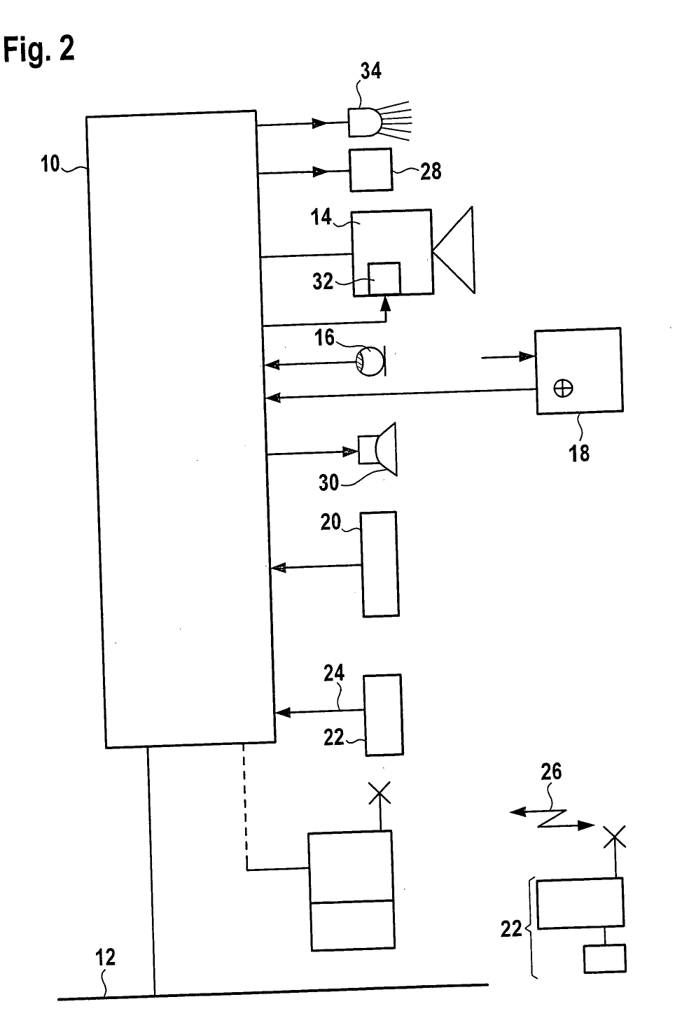

FIG. 2 shows a block diagram of a monitoring device arranged on the object to be monitored. A control unit 10, which can be arranged e.g. in the housing of a camera, is connected to a transmission medium 12. The transmission medium can be a local transmission medium, such as e.g. a line or radio system, a bus system, a wireline network, such as LAN, a radio network, such as WLAN, or a public transmission medium, such as fixed network telephone, fixed network Internet, or radio networks, such as GSM or UMTS.

Connected to control unit 10 also are a camera 14 and sensors and actuators. The sensors can be acoustic sensors, e.g. microphones 16, alarm sensors 18, such as shock sensors or glass-breaker sensors, meteorological sensors 20 for detecting temperature, humidity, wind speed or motion sensors 22 based on infrared, ultrasound or radar or light barrier sensor. The sensors can be connected via lines 24 or be wireless, e.g. connected via radio 26, to control unit 10. In addition, control unit 10 can also have outputs for controlling actuators, such as optical or acoustic alarms 28, sound playback instruments, sound transducers 30, auto-shot devices; electromechanical means 32 for controlling the camera settings, such as horizontal and vertical angles and zoom and light sources, e.g. infrared lighting 34. The control commands for controlling the outputs and the attached actuators can be sent by the central monitoring unit via transmission medium 12 to control unit 10 or activated locally in control unit 10 of the camera itself.

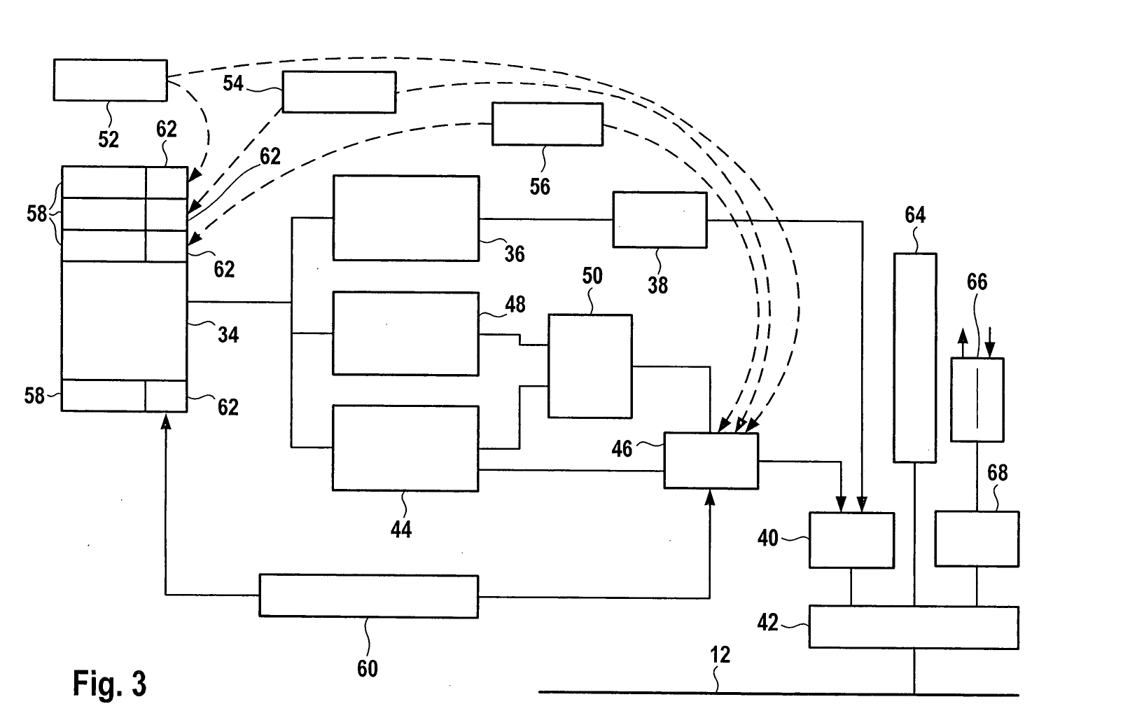

FIG. 3 shows a detailed block diagram of a signal processing device of the monitoring device for a camera 34. The camera is a video camera, at the output whereof analog or digital signals are output. In a memory 36 of a coder a total image is stored and this is sent by means of a timer 38 to a coder 40 for image data. The latter compresses the image data and passes it on via a combined priority circuit and send/receive device 42 to a transfer medium 12.

A first image section is selected from the total image of the camera and interim-stored in a memory 44. This first image section is likewise fed by a timer 46 to coder 40 and by the combined priority circuit and send/receive device 42 to the transmission medium 12. The image section is more frequently transmitted by means of timer 46 than the total image is by means of timer 38.

In addition, more image data of a detection area are also stored in a memory 48 as second image section. The present circuit handles the case where the first image section and the second image section match and images of camera 34 are stored at staggered times in memory 44 for the first image section and memory 48 for the second image section. Changes to the image content are compared by a downstream comparator 50. In the case of deviations, which suggests a motion event, timer 46 is activated to immediately transmit a series of further image data of the section in addition to its static setting. Triggering transmission of the section independently of changes of the image content can occur via sensors and trigger circuits 52, 54, 56 for other physical events. The control unit of camera 34 can itself also switch on an acoustic sensor, such as e.g. a microphone or actuator, such as e.g. a loud speaker.

In the embodiment, camera 34 is designed as a dome camera and the camera settings can be adjusted by means of a control device 58 at a horizontal angle, vertical angle and in zoom. The camera setting can also be changed by means of sensors and trigger circuits 60 for other physical events, which are integrated in the camera casing or are arranged externally. For this, different camera settings for different sensors are stored in memories 62, which are executed when initializing criteria are fulfilled or when the sensors are touched off. Due to altered camera settings, transmission of a total image can be made via timer 38 and transmission of image data of the section can be made via timer 46.

Additionally, sensor data from a signal-processing device 64 can also be supplied via combined priority circuit and send/receive device 42 to transmission medium 12 and transmitted. Acoustic information can also be supplied via a signal-processing device 66 over the combined priority circuit and send/receive device 42 to the transmission medium 12 and transmitted or received. A further coder 68 is arranged between the signal-processing device 66 and the combined priority circuit and send/receive device 42 for data reduction of bidirectional acoustic information.

Transmission of data via priority configurations can take place by the combined priority circuit and send/receive device 42 in advance of transmission of other data.

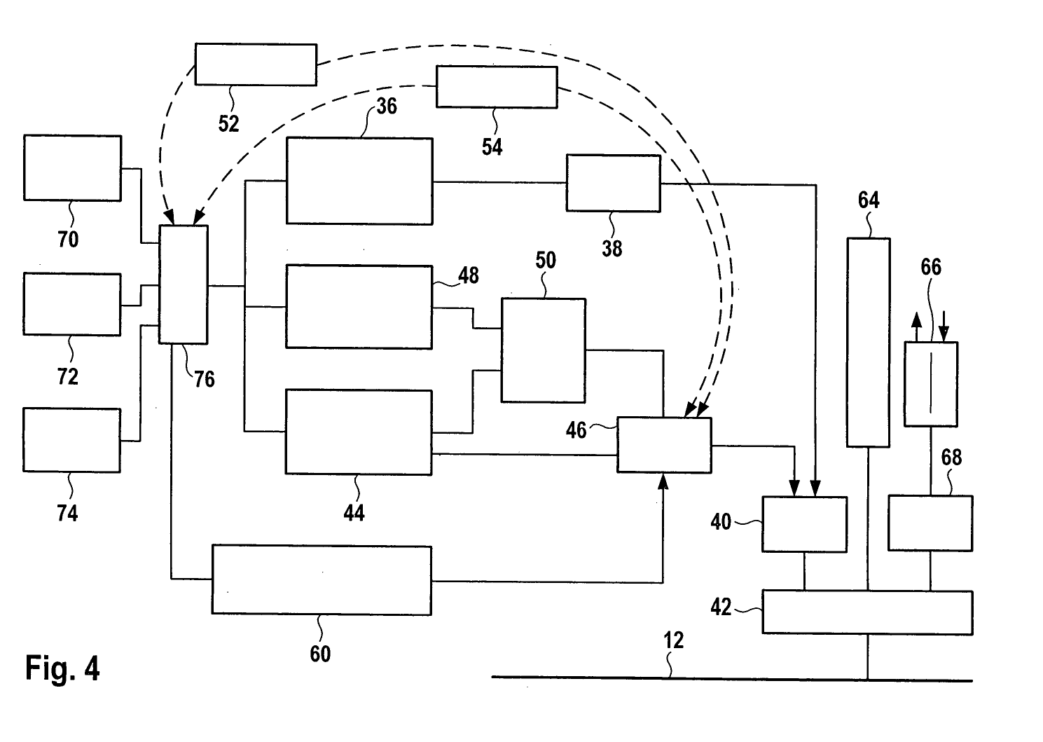

FIG. 4 shows a detail of a first block diagram of a signal-processing device of the monitoring device for several cameras. Here the individual cameras 70, 72, 74 are connected to a multiplexer 76, which feeds the camera signals of a common image-processing circuit. This corresponds essentially to the circuit according to FIG. 3. By way of internal or external sensors and trigger circuits 52, 54, 50, connected to the multiplexer 76, those data from cameras 70, 72, 74 can be switched through in priority via the multiplexer 76, whereof the images are weighted as particularly relevant for transmission due to triggering by the sensors.

Even when deviations in the detection area occur in one of the cameras 70, 72, 79 this event can be assessed for priority controlling.

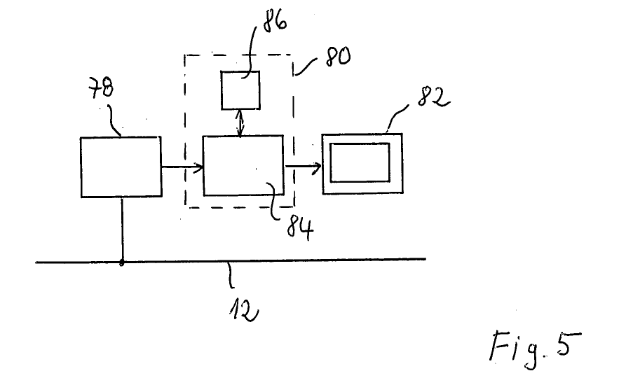

FIG. 5 shows a block diagram of the receiving arrangement according to the invention. The receiving arrangement is connected to a transfer medium 12 and encompasses a receiving device 78. A decoder 80 is connected to receiving device 78. Connected to decoder 80 is a program-guided image processing control 84, a memory 86 and a monitor 82.

Accordingly, while only a few embodiments of the present invention have been shown and described, it is obvious that many changes and modifications may be made thereunto without departing from the spirit and scope of the invention.

What is claimed is:

1. A process for remote transmission of data, comprising:
transmitting image data of a total image at least once;
transmitting image data of at least one section of the total image relevant to monitoring;
updating said image data of said at least one section by transmitting updated image data repeatedly over time; and
replacing said image data of said at least one section with said updated image data,
wherein said updated image data of said at least one section is transmitted at more frequently than the image data of the total image.

2. The process as claimed in claim 1, further comprising the step of:
establishing initializing criteria; and
performing an action once said initializing criteria are fulfilled, said action selected from the group consisting of: transmission of image data of the total image or at least one section, changing the camera setting, activating sensors, activating optical or acoustic signallers, activating light sources, and activating alarms.

3. The process as claimed in claim 2, wherein the initializing criteria comprises changes to the camera setting.

4. The process as claimed in claim 3, wherein when the initializing criteria are fulfilled, at least one section of the total image is fixed anew, modified or on the basis of stored criteria.

5. The process as claimed in claim 2, wherein the initializing criteria are selected from the group consisting of: data of a sensor, data of a meteorological sensor, data of an acoustic sensor, data of a motion sensor, data of a light barrier sensor, a combination of data of at least two sensors, in a detection area fixed inside the total image, in which changes in image information occur.

6. The process as claimed in claim 3, wherein when the initializing criteria are fulfilled by a modified camera setting, wherein at least one detection area is fixed anew, modified or on the basis of stored criteria.

7. The process as claimed in claim 5, wherein the initializing criteria are selected from the group consisting of changes of image information, quantity of image information, localized distribution of image information and a combination thereof.

8. The process as claimed in claim 5, wherein the initializing criteria are assessed by an internal detection decision circuit of the camera, and wherein transmission of data of the total image or of the section over a transmission medium is caused by the internal detection decision circuit of the camera only when at least one initializing criterion or a combination of initializing criteria is fulfilled.

9. The process as claimed in claim 5, wherein the initializing criteria are assessed by an internal detection decision circuit in the camera, such that when an initializing criterion or a combination of initializing criteria is fulfilled, at least one local action is triggered, and the initializing criteria are then continued or analyzed anew, individually or in combination or in combination with said at least one local action, and wherein transmission of data of the total image or of the section over a transmission medium is undertaken by the internal detection decision circuit of the camera only when an initializing criterion or a combination of initializing criteria is fulfilled.

10. The process as claimed in claim 5, further comprising the step of fixing at least one detection area for a camera setting at least once.

11. The process as claimed in claim 5, wherein at least one detection area is delimited temporarily once or by ongoing transmissions and is restricted or expanded by statistical evaluation of changes of image information inside or outside the temporary detection area.

12. The process as claimed in claim 5, wherein at least one section of the total image is temporarily delimited once or by preceding transmissions and is restricted or expanded by statistical evaluation of changes to image information inside or outside the detection area.

13. The process as claimed in claim 1, wherein the image data of the total image is transmitted as animated image in compressed form or as a still image in compressed form.

14. The process as claimed in claim 1, wherein the image data of at least one section of the total image are transmitted as animated image in compressed form or as a still image in compressed form.

15. The process as claimed in claim 1, further comprising the step of transmitting data of a antiburglar sensor or a meteorological sensor or an acoustic sensor or a motion sensor or a light barrier sensor or a combination of at least two of the sensors in uncompressed or in compressed form.

16. The process as claimed in claim 1, wherein after transmission of said least one section of the total image, said section is integrated into the total image by balancing image parameters.

17. The process as claimed in claim 16, wherein said at least one section of the total image is marked inside the total image.

18. The process as claimed in claim 5, wherein said at least one detection area is marked outside the total image.

19. The process as claimed in claim 1, wherein image data is transmitted from several cameras, and during transmission of said image data from several cameras, priority configurations are assigned to the image data and the available transmission bandwidth, or transmission sequences of these image data is allocated by means of priority configurations, wherein the priority configurations are weighted according to fixed or dynamic criteria.

20. The process as claimed claim 19, wherein during transmission of said image data from several cameras, said cameras capture adjacent or overlapping areas of a total image and the image data are expanded into a total image.

21. The process as claimed in claim 7, wherein additional data is transmitted from one of a break-in sensor or a meteorological sensor or an acoustic sensor or a motion sensor or a light barrier sensor, in addition to transmission of image data, and wherein priority configurations are assigned to the data of the antiburglar sensor, the meteorological sensor, the acoustic sensor, the motion sensor, or the light barrier sensor, and the image data, and an available transmission bandwidth or transmission sequence is allocated to these additional data by means of their priority configurations.

22. An arrangement for remote transmission of data, comprising:
at least one camera for generating image data of a total image,
a coder connected to the camera for storing the image data of said total image;
a decoder connected to the coder and comprising a memory and a program-controlled image-processing circuit adapted to select at least one current section of the total image generated by said camera and further comprising a program-controlled image-processing circuit, for inserting updated image data of the section into the image data of the total image and storing said updated data of said total image and said section in said memory;
a sending device connected to the decoder for transmitting data of the total image and the section from the decoder;
a transmission medium for transmitting said data of the total image and the section from the sending device;
a receiver device for receiving said data of the total image and the section from the sending device via the transmission medium; and
a monitor connected to the receiver device for displaying the transmitted data,
wherein the arrangement is programmed to transmit image data of the section of the total image more frequently than image data of the total image.

23. The arrangement as claimed in claim 22, further comprising a trigger circuit connected to the coder, said trigger circuit initiating transmission of image data of at least one section based on initializing criteria.

24. The arrangement as claimed in claim 23, wherein the trigger circuit comprises a time control or a screwed-down or program-controlled detection decision circuit, which detects data of an antiburglar sensor or a meteorological sensor or an acoustic sensor or a motion sensor or a light barrier sensor or a combination at least of two of said sensors, which detect data of a detection area fixed inside of the total image, in which modifications to image information take place.

25. The arrangement as claimed in claim 22, wherein the coder comprises a program-controlled or hardware-controlled image data compression circuit and the decoder comprises a program-controlled or hardware-controlled image data expansion circuit.

26. The arrangement as claimed in claim 22, wherein at least one antiburglar sensor or at least one meteorological sensor or at least one acoustic sensor or at least a motion sensor or a light barrier sensor or a combination of at least two of these sensors is connected to the coder, and data of the sensors is linked by means of the coder to the image data, and is transmitted by the sending device via the transmission medium to the receiver device, and the data of the sensors is selected by means of the decoder and displayed on the monitor.

27. The arrangement as claimed in claim 26, wherein the coder comprises a program-controlled bandwidth allocation circuit or a multiplexer, that allocates image data and sensor data by priority configurations, and wherein required bandwidth of the image data and sensor data and available bandwidth of the transmission medium are allocated according to transmission bandwidth or transmission sequence.
